(19) United States
(12) Patent Application Publication
(10) Pub. No.: US 2003/0150716 A1
(43) Pub. Date: Aug. 14, 2003

(54) Electrochemically driven monolithic microfluidic systems

(76) Inventors: Zonglu Susan Hua, Williamsville, NY (US); Harsh Deep Chopra, Williamsville, NY (US); Frederick Sachs, Eden, NY (US)

Correspondence Address: George L. Snyder, Jr., Hodgson Russ LLP, Suite 2000, One M&T Plaza, Buffalo, NY, 14203-2391, US

(21) Appl. No.: 10/305,459

(22) Filed: Nov. 26, 2002

Related U.S. Application Data
(60) Provisional application No. 60/333,834, filed on Nov. 28, 2001.

(51) Int. Cl. B01J 8/08

(52) U.S. Cl. 204/232; 205/687

(57) ABSTRACT

A microfluidic system and method, suitable for “lab-on-a-chip” applications, by which a bubble is inflated in fluid flowing through a microfluidic channel at a predetermined location along the channel and the bubble is maintained at that location to stop flow through the channel in the manner of a valve. The microfluidic channel is formed on a semiconductor chip and a pair of electrodes is formed one on each side of the channel, whereby a bubble is electrochemically inflated between the electrodes and held in fixed position by the channel wall when a voltage is applied across the fluid incident to connecting the electrodes to a voltage source. When the voltage is removed, deflation of the bubble valve rapidly occurs to restore flow. The present invention provides flow control in a microfluidic system regardless of channel cross-sectional geometry and with no moving parts and low power consumption. Moreover, the present invention may be practiced using existing fabrication techniques.

### CROSS-REFERENCES TO RELATED APPLICATIONS

This application claims the benefit of U.S. Provisional Application No. 60/333834 filed Nov. 28, 2001.

### STATEMENT REGARDING FEDERALLY SPONSORED RESEARCH

The U.S. government has a paid-up license in this invention and the right in limited circumstances to require the patent owner to license others on reasonable terms as provided for by the terms of Grant No. 0201293 awarded by the National Science Foundation.

### FIELD OF THE INVENTION

The present invention relates generally to the field of microfluidic systems, and more particularly to a method and apparatus for regulating fluid flow through a microfluidic channel.

### DESCRIPTION OF RELATED ART

Micro-electromechanical systems (MEMS) continue to spawn new technological applications and serve as catalysts for key scientific discoveries. Intense efforts are currently underway to develop multi-functional microfluidic chips, a technology commonly referred to as “lab-on-a-chip”. Applications include, among others, combinatorial and analytical chemistry, drug discovery, microbiology, biotechnology, and drug delivery. To regulate fluid flow through labyrinthine microfluidic channels using pumps and valves, various actuation mechanisms, based on piezoelectricity, electrostatics, thermo-pneumatic, and electromagnetism have been developed, along with advances in microfabrication, for example, “soft” lithography.

Bubble-based actuators are of interest because they are simple to fabricate and the bubbles have an ability to readily conform physically to different channel cross-sectional shapes. Both thermal and electrochemically generated bubbles have been used. By way of example, bubbles have been used to actuate a mechanical gate valve element; see Papavasiliou, A. P.; Pisano, A. P.; and Liepmann, D., “Electrolysis-Bubble Actuated Gate Valve”, Proc. of the 11^{th} Int'l Conf. On Solid State Sensors and Actuators, Germany, 2001, pages 940-943. As a further example, a bubble has been moved to and trapped at a flow restriction in a microchannel to itself serve as a valve for blocking flow, however such technology suffers from problems associated with removing the bubble from the channel flow path to allow flow to resume; see Ki, Y. -S. L.; Kharouf, M.; Lintel, H. T. G. van.; Haller, M.; and Renaud, Ph., “Bubble Engineering for Biomedical Valving Applications”, 1^{st} Annual International IEEE-EMBS Special Topic Conference on Microtechnologies in Medicine and Biology, Lyon, France, Oct. 11-14, 2000, pages 390-393. While electrochemical bubbles require low power in the microwatt range, and the bubble inflation rates are comparable to thermal bubbles, their use has been limited by slow bubble deflation rates, since the dissolution of gas into the fluid is kinetics-limited.

### SUMMARY OF THE INVENTION

A microfluidic system formed in accordance with an embodiment of the present invention comprises a semiconductor chip including a microfluidic channel through which a fluid flows, and valve means for inflating a gas phase bubble in the fluid at a location along the channel, wherein the bubble is held stationary at the location it was inflated to restrict flow through the channel. To open the bubble valve, the bubble need not collapse fully since the only requirement to restore flow through the channel is that the hydraulic resistance of the fluid between the bubble and the channel wall be less than that of the open channel. Experimentally this has been found to occur at bubble diameters only slightly smaller than the channel cross-section, a deflation process requiring only milliseconds. The small channel dimensions characteristic of a microfluidic chip are therefore well suited and enhance deflation rates because the surface to volume ratio of the bubble increases with reduced dimensions, and for a given interfacial tension, the internal bubble pressure increases with decreasing channel dimensions.

A valve means suitable for practicing the present invention comprises a pair of electrodes positioned on opposite sides of the channel at a chosen location along the channel. The electrodes communicate with the channel to contact fluid flowing through the channel, such that when the electrodes are connected to a voltage source and a voltage is applied across the fluid, a bubble is generated electrochemically between the electrodes. When the applied voltage is removed, the bubble quickly deflates to open the valve and restore flow. Thermal bubble generation is an alternative to electrochemical bubble generation.

The present invention also encompasses a method of regulating flow of a fluid through a microfluidic channel comprising the steps of inflating a gas phase bubble in the fluid at a location along the channel and maintaining the bubble at the location. In a working embodiment, the bubble is inflated electrochemically by applying a voltage across the fluid, and the bubble is maintained at the location of inflation by an inner wall of the channel. The invention further encompasses a method of temporarily stopping flow of a fluid through a microfluidic channel comprising the steps of applying a voltage across the fluid to electrochemically inflate a gas phase bubble in the fluid, maintaining the bubble at a fixed location along the channel; and removing the voltage after a period of time to allow the bubble to deflate.

As will be appreciated, the present invention provides a microfluidic system valve suitable for “lab-on-a-chip” applications that has no moving parts, operates at high speed and contollability with low power consumption, and conforms to any microfluidic channel cross-sectional shape. Moreover, in accordance with a present electrochemical embodiment, the functional life of the valve is limited only by the effective life of the electrodes.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic diagram of a microfluidic system embodying the present invention;

FIG. 2 is a scanning electron micrograph of a portion of a microfluidic channel formed in accordance with an embodiment of the present invention;

FIGS. 3A-3F are optical micrographs showing inflation and deflation of a gas phase bubble in fluid flowing through a microfluidic channel in accordance with an embodiment of the present invention;

FIGS. 4A-4F are fluorescent microscopy images corresponding to the optical micrographs of FIGS. 3A-3F and showing the interaction between the bubble and fluid flow using polystyrene fluorescent microspheres as tracers of flow;

FIG. 5A is a graph showing voltage versus time for an applied voltage pulse associated with bubble inflation and deflation shown in FIGS. 3A-3F and FIGS. 4A-4F;

FIG. 5B is a graph showing current versus time for measured current through electrodes used in applying the voltage pulse shown in FIG. 5A;

FIG. 6A is a graph plotting flow rate versus time for four different starting flow rates as a bubble valve closes flow through a microfluidic channel, wherein the bubble is generated by a voltage pulse having a magnitude of 3.8 Volts;

FIG. 6B is a graph similar to that of FIG. 6A, however the bubble is generated by a voltage pulse having a magnitude of 4.2 Volts;

FIG. 6C is a graph similar to those of FIGS. 6A and 6B, however the bubble is generated by a voltage pulse having a magnitude of 4.6 Volts;

FIG. 6D is a graph plotting flow rate versus time for two different starting flow rates as a bubble valve closes flow and then collapses to open flow through a microfluidic channel;

FIG. 7A is a schematic diagram of a microfluidic channel and electrochemical reactions occurring at an anode and a cathode in accordance with a microfluidic system of the present invention;

FIG. 7B is a fluorescent microscopy image showing the spatial extent of solution chemistry variation delineated by a pH sensitive fluorescent dye in a microfluidic channel formed in accordance with an embodiment of the present invention, wherein no voltage is applied;

FIG. 7C is an image similar to that of FIG. 7B, however a voltage is applied;

FIG. 7D is an image similar to that of FIG. 7C, however the image is taken with HEPES buffering added to the solution to suppress any pH gradients;

FIG. 8A is an optical micrograph of an eight-way multiplexer based on electrochemical bubble valves in accordance with an embodiment of the present invention;

FIG. 8B is a fluorescent micrograph showing fluid being directed to output channel #6 of the multiplexer shown in FIG. 8A; and

FIG. 8C is a fluorescent micrograph showing fluid being directed to output channel #5 of the multiplexer shown in FIG. 8A.

### DETAILED DESCRIPTION OF THE INVENTION

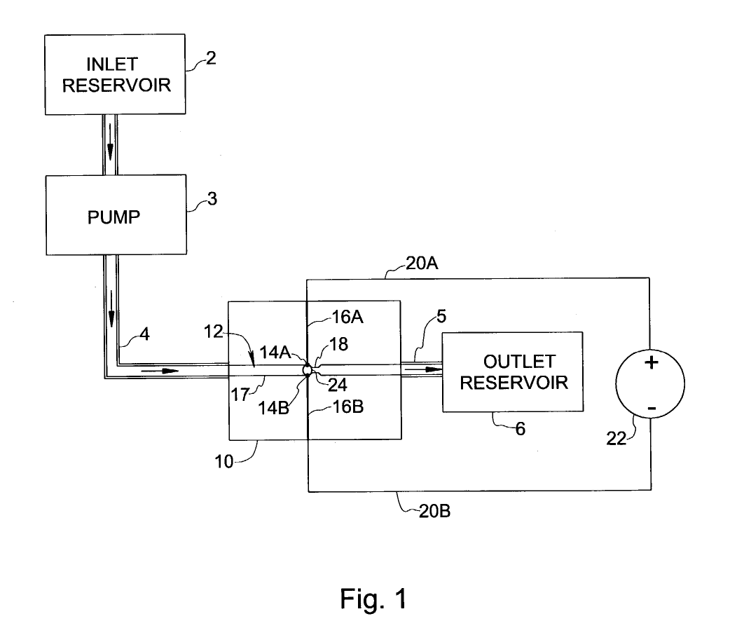

Referring initially to FIG. 1 of the drawings, a microfluidic system formed in accordance with an embodiment of the present invention is depicted schematically for sake of understanding. The microfluidic system includes a body 10 having a microfluidic channel 12 through which a fluid flows from left to right in FIG. 1 as indicated by the arrows. An anode 14A and a cathode 14B are positioned on opposite sides of channel 12 and are connected to a voltage source 22 through conductive lines 16A and 16B integral with body 10 and external lines 20A and 20B, respectively. Channel 12 is preferably characterized by a feeder portion 17 and a neck portion 18 adjacent to and downstream from feeder portion 17, wherein neck portion 18 has a reduced cross-sectional area relative to feeder portion 17. Elements for delivering fluid to channel 12 and receiving fluid from channel 12 are also shown, and generally include an inlet reservoir 2 and a pump 3 connected along an inlet tube 4, and an outlet tube 5 leading to an outlet reservoir 6. In accordance with the present invention, and as will be described hereinbelow in connection with working embodiments, electrodes 14A and 14B permit a voltage to be applied across a fluid flowing through channel 12 to electrochemically inflate a bubble 24 that is prevented from being carried downstream from its location of inflation by an inner wall of the channel.

### EXAMPLES

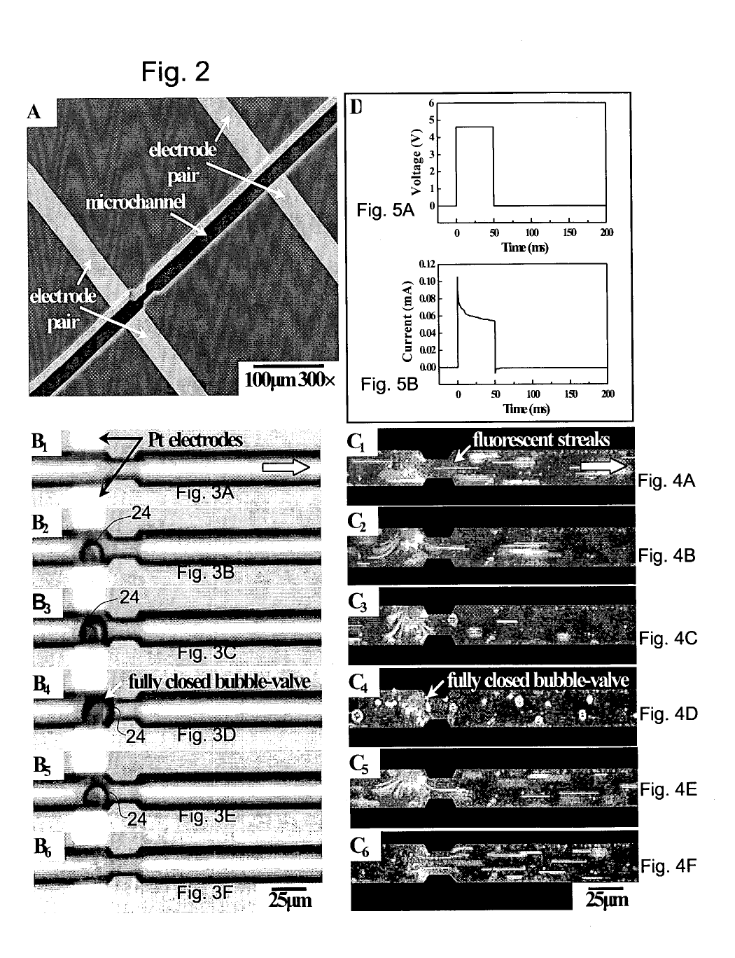

The microfluidic chips used to test the mechanical and chemical characteristics of bubble-valves consisted of a fluid channel connecting an inlet and an outlet reservoir, and anode/cathode electrode pairs perpendicular to the channel to generate bubble valves at different locations. FIG. 2 shows a scanning electron micrograph (SEM) of a portion of the channel (the inlet and outlet reservoirs are not shown) showing two sets of electrode pairs along the length of the channel. The microfluidic system was micromachined on a silicon wafer using standard microfabrication techniques. The channel was 25 μm square in cross-section and 5.2 mm long. Near one pair of electrodes, a 15 μm wide neck was introduced to create a backpressure, although from experiments it was subsequently found that surface forces alone were adequate and the neck was not needed to prevent the bubble from flowing downstream. Following photolithography, the channel was first etched to 25 μm in depth using deep reactive ion etching. Platinum (Pt) electrodes were then deposited by e-beam deposition followed by lift-off. The Pt electrodes were 300 nm thick and 25 μm wide. Finally, a poly(dimethylsiloxane) (PDMS) film (using Sylgard-184, Coming) was used to cover and seal the etched channel. Silicone tubing with 0.3 mm inner diameter was placed within the PDMS film during the curing process, and this tubing was subsequently aligned on top of the inlet and outlet reservoirs.

A syringe pump connected to a pressure reservoir perfused the channel with electrolyte. The flow rate was adjusted by changing the inlet pressure while the outlet was kept at atmospheric pressure. Whereas the experimental results in the following pertain to 1.0 M NaCl in distilled water (pH=6.4), various other common and useful laboratory reagents were also successfully tested. These included NaCl (0.1 M-1.0 M), weak acids (1.0 M acetic acid and oxalic acid), strong acids (0.1 M-1.0 M hydrochloric acid and sulfuric acid), and bases (10⁻⁵ M to 1.0 M NaOH), as well as non-aqueous/water mixtures such as ethanol/water, acetonitrile/water in varying proportions (using analytical grade reagents). In particular, electrolysis of aqueous NaCl releases H₂ gas at the cathode (2H₂O+2e⁻→H₂ (g)+2OH⁻, E°=− 0.83 V), and Cl₂ gas at the anode (2Cl⁻→Cl₂ (g)+2e⁻, standard reduction potential E°=+1.36 V), with an overall cell E°=−2.19 V. Note that water is always reduced in preference to Na⁺ ions at the cathode since water accepts electrons more readily (E° for Na⁺+e⁻→ Na being −2.71 V). A secondary reaction can occur as a small amount of Cl₂ gas reacts with water to form HOCl (hypochlorous acid) and HCl: Cl₂(g)+H₂O [symbol] H⁺+OCl⁻+H⁺+Cl⁻. However, note that this secondary reaction is not an electrochemical reaction and does not rely on charge transfer occurring at the electrodes. Moreover, the effect of this reaction is expected to be negligible because it is very slow and bubbles of useful sizes can be easily formed even in very dilute solutions and in a wide range of solution chemistries. In the present example, the voltage required to generate bubbles was 3.3 V instead of 2.19 V. The need for a slightly higher voltage (referred to as over-voltage in electrochemistry) is well known and is commonly observed due to non-equilibrium kinetics of electron transfer, especially when a gas phase is present. Hydrostatic pressures above one atmosphere also favor the dissolution of gas into water, thereby increasing the over-voltage for the formation of Cl₂ gas. Bubble-valves were characterized for voltages from 3.3 V to 8.0 V. An arbitrary waveform function generator was used to apply a square voltage pulse across the fluid between the anode and cathode. The bubble valve's characteristics were simultaneously observed with an optical microscope and video-recorded for later image analysis. An examination of video recordings of thousands of triggered bubbles at the Pt electrodes (on a given chip) showed no discernible degradation or damage to the electrodes (initially, the microfluidic chips were made using gold, which was found to dissolve away rapidly during bubble generation). Fluorescent microspheres 0.02 μm diameter (polystyrene fluorescent microspheres, Nile Red F-8784) from Molecular Probes (Seattle) were used to visualize the interaction of fluid flow with the bubble valves and also to measure the flow velocities.

FIGS. 3A-3F comprise a series of optical micrographs showing bubble inflation and deflation. The dark edges near the channel wall are an optical artifact. FIGS. 4A-4F are fluorescent microscopy images corresponding to the optical micrographs of FIGS. 3A-3F showing valve closing and opening, wherein the interaction between the bubble and the flow was visualized using polystyrene fluorescent microspheres as tracers of flow (0.02 μm diameter, Nile Red F-8784, Molecular Probes, Seattle). FIGS. 5A and 5B show the profile of the applied voltage pulse and of the measured current through the electrodes, respectively.

FIGS. 3A-3F show a sequence of bright field optical images of bubble growth and deflation, whereas FIGS. 4A-4F show the corresponding fluid flow images as visualized by fluorescent microscopy wherein the streak length of fluorescent microspheres is an indicator of fluid velocity. FIGS. 3A and 4A show fluid flow in the channel prior to triggering of an electrochemical bubble (measured open flow rate 16 mm/s, inlet pressure 103 kPa). Upon triggering a voltage an electrolytic bubble is nucleated, as shown in FIG. 3B. Importantly, the corresponding fluorescent image in FIG. 4B shows no measurable reduction in flow rate (as seen from unchanged streak length with respect to FIG. 4A) even though the bubble is more than half the channel width; the flow trajectories of beads can be seen curving over the bubble in FIG. 4B. FIGS. 3C and 4C show that only when the bubble grows to a sufficiently large size does the flow rate begin to show a marked decrease, as seen from shorter fluorescent streaks in FIG. 4C. Finally, when the bubble grows to completely block the channel, as seen in FIG. 3D, the bubble fully stops the flow and the beads become static, subject only to Brownian motion. Consequently, in FIG. 4D, the fluorescent beads are visible as spots with circular halos. Note that the fluorescent microspheres are only 0.02 μm in diameter and they cannot be resolved in the optical micrographs in FIGS. 3A-3F. Instead, it is the halo associated with them that manifests as bright streaks when the fluorescent beads are in motion, as in FIGS. 4A-4C and FIGS. 4E-4F. When the flow is stopped on closing the valve (FIG. 4D), the microspheres appear as bright spherical halos. The observed variation in the size of spherical halos in FIG. 4D is mainly due to the limited depth of focus of an optical microscope. FIG. 3E shows the bubble as it begins to deflate. Significantly, the corresponding image in FIG. 4E shows that full flow is already restored at this stage. Thus the valve opening does not require full bubble collapse (as in FIGS. 3F and 4F). Instead, the restoration of full flow requires only a slight collapse of the bubble, which occurs in a short period of time of the order of milliseconds (quantitatively characterized in the following). It is also clear from FIG. 4D that the shut valve does not leak despite the fact that the channel has a square cross-section. It is this ability of the bubble to conform to arbitrary geometries (in the present case square cross-section) that makes bubble-valves robust. FIG. 5B shows the current response to a square wave voltage pulse (4.6 V, 50 ms; see FIG. 5A) applied to the pair of electrodes. Between the two current spikes in FIG. 5B, the current decays with time, and this decay is associated with the nucleation and growth of bubbles at the electrodes in the microchannel. It is observed that the energy required to generate the bubble is very small, on the order of ≈10 μJ.

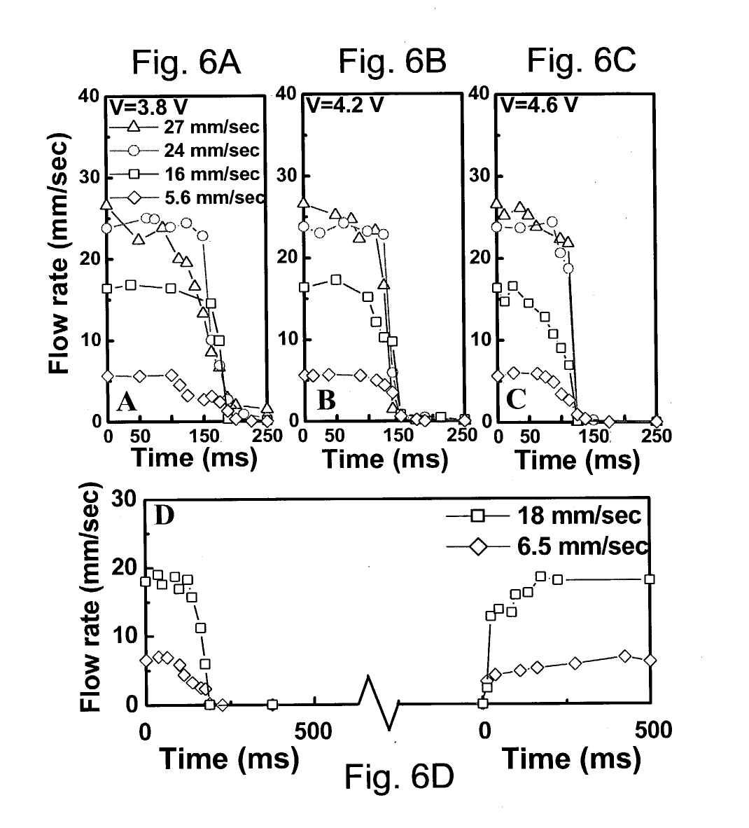

FIGS. 6A-6C graphically illustrate the valve closing characteristics for three different voltages, viz., 3.8 V, 4.2 V, and 4.6 V, respectively. For each driving voltage, the valve closing was characterized at four different flow rates, viz., 5.6 mm/s (inlet pressure 102 kPa), 16.4 mm/s (inlet pressure 103 kPa), 23.8 mm/s (inlet pressure 104 kPa), and 26.6 mm/s (inlet pressure 105 kPa). The flow rates are given in units of velocity instead of flux so as to enable comparison with literature citing channels with different cross-sectional areas. FIG. 6A shows that the 3.8 V applied voltage is capable of shutting all flow with moderate applied pressures up to 104 kPa. Shutting off the flow at higher pressures simply required a slightly higher voltage, as shown in FIGS. 6B and 6C. In other words, the flow can be regulated simply by tuning the voltage to suit a given flow rate and channel cross-section. Although low camera light intensity at high shutter speeds to record fast moving fluorescent beads prevented data recording at higher flow rates, flow regulation was successfully tested by visual observation up to inlet pressures as high as 110 kPa. Also note that the ability of a bubble valve to withstand high pressures is related to the design of the fluid channel and the surface conditions. For example, experimental and theoretical calculations show that by making the channel width at the neck region smaller, the bubble can be made to withstand even higher inlet pressures. Also note from FIGS. 6A-6C that the valve closing rate (slope of the curves) becomes steeper with higher applied voltage. The valve opening response is shown in FIG. 6D for two different flow rates. In FIG. 6D the corresponding valve closing curves are also shown on the left portion of the graph to enable a comparison between valve closing and opening rates. Also note that the time for which the valve is desired to stay fully closed in FIG. 6D (time between valve closing and opening) can simply be changed by keeping the applied voltage to any desired length of time. As seen from FIG. 6D, both opening and closing can be completed within ≈30 ms. While the valve closing rate increases with higher voltage as indicated by FIGS. 6A-6C, the valve opening rates depend upon the rate of bubble collapse. As shown above, full collapse of the bubble is not required to open the valve, since the valve opens when hydraulic resistance of the region containing the bubble becomes comparable to that of channel (as seen in FIGS. 3E and 4E). The rate of collapse depends upon the rate of gas dissolution into the liquid, which in turn depends upon the surface to volume ratio of the bubble and the surface tension of the interface. For spherical bubbles of radius r at a fixed hydrostatic pressure, the rate of collapse is proportional to 3RTφ/4r where φ is the permeability of the gas-liquid interface and RT is the gas constant times the temperature. Thus, smaller bubbles tend to collapse faster than large ones so that microfluidic channels are better suited as their dimensions are further reduced. As a closed valve begins to open, the liquid flow also washes away the dissolved gas (not the bubble) at a higher rate and favors further collapse.

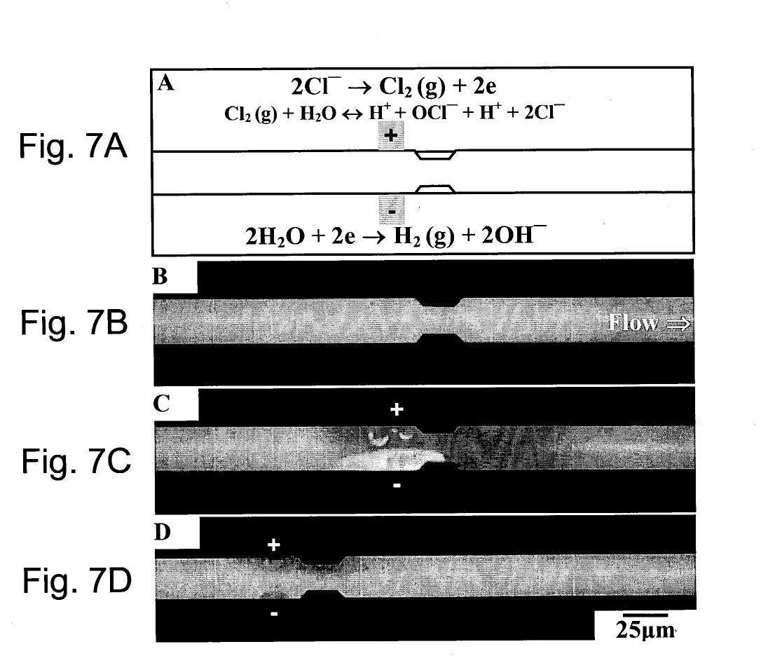

Because less than a picomole of salt is needed to generate a bubble of useful size, pH gradients that are invariably associated with electrochemical reactions can readily be suppressed by mild buffering. The electrolysis effect on solution pH with and without buffer was studied by using a pH sensitive fluorescent dye. FIG. 7A schematically shows the half-cell reactions at the anode and the cathode; the secondary reaction at the anode is shown in smaller case. FIG. 7B shows a fluorescent image in a non-buffered solution flowing in the channel. In accordance with the above-described electrochemistry, upon applying a voltage, the fluorescence around the cathode becomes brighter (representing an increase in pH) and that near the anode becomes darker (decrease in pH), as seen in FIG. 7C. To illustrate that a buffer can indeed easily and readily suppress pH gradients generated during electrochemical process, 50 mM of HEPES buffer (N-2-Hydroxyehtylpeperazine-N′-2-ethanesulfonic acid, C₈H₁₇N₂NaO₄S) was added to the 1 M NaCl solution, and the electrochemistry was repeated under the same condition. HEPES is a common buffer that is used in a wide range of biological applications, including those involving electrochemical processes. As shown in FIG. 7D, the buffer readily renders any pH gradients negligible that are generated during electrolysis. The dark areas in FIG. 7D in the vicinity of the electrodes are electrolysis bubbles.

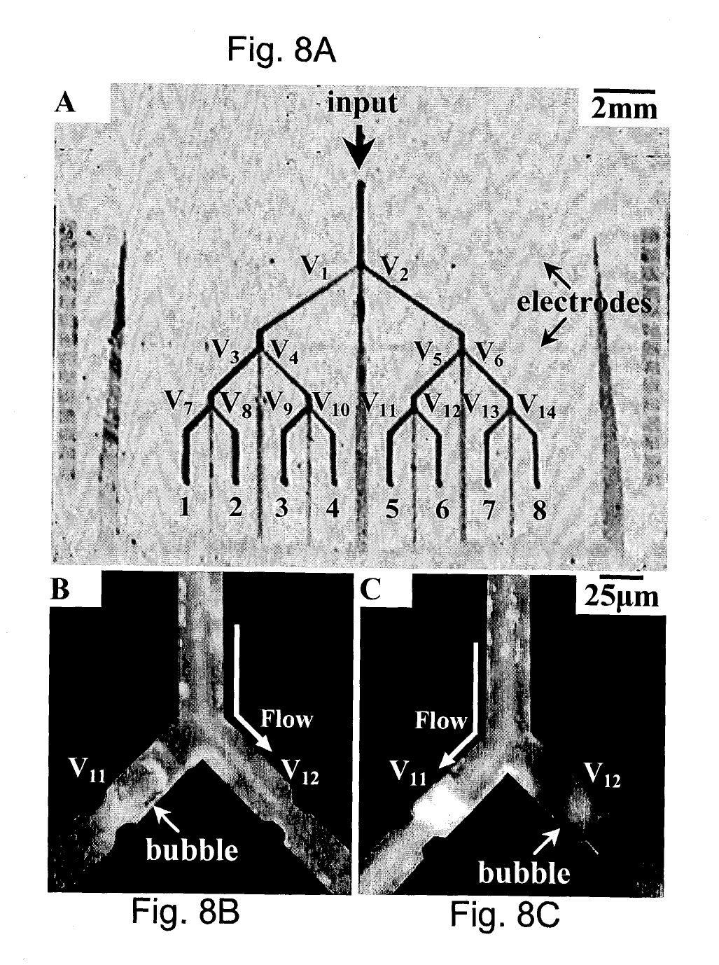

Finally, an eight-way prototype multiplexer was built to further study the feasibility of making more complex microfluidic chips in accordance with the present invention. An optical micrograph of the multiplexer is shown in FIG. 8A. The multiplexer required the same steps as those needed to make the above described systems. The distribution channels in FIG. 8A have a 25 μm square cross-section. The multiplexer chip in FIG. 8A consisted of one inlet channel and 2ⁿ (n=3) outlet channels such that the fluid can be distributed to any of the 2ⁿ (=8) channels by closing just n (=3) valves. FIGS. 8B and 8C show the fluorescent optical micrographs of the flow being switched alternately between output channel #5 and output channel #6, respectively. In FIG. 8B, the fluorescent light streaks in the channel show the flow being directed to channel #6 by keeping the valves V_{1,} V₆ and V₁₁ closed, whereas in FIG. 4C the flow is shown directed to channel #5 by keeping the valves V_{1,} V₆ and V₁₂ closed.

What is claimed is:

1. A microfluidic system comprising:
a body including a microfluidic channel through which a fluid flows; and
valve means for inflating a gas phase bubble in said fluid at a location along said channel;
wherein said bubble is stationary at said location to restrict flow through said channel.

2. The microfluidic system according to claim 1, wherein said channel defines a single flow path at said location.

3. The microfluidic system according to claim 1, wherein said valve means includes an anode and a cathode arranged to apply a voltage across said fluid when said anode and cathode are connected to a voltage source, whereby said bubble is inflated electrochemically.

4. The microfluidic system according to claim 3, wherein said anode and said cathode are each in contact with said fluid.

5. The microfluidic system according to claim 3, wherein said anode and said cathode are respectively arranged on opposite sides of said channel.

6. The microfluidic system according to claim 5, wherein said channel includes a feeder portion and a neck portion adjacent to and downstream from said feeder portion, said neck portion having a reduced cross-sectional area relative to said feeder portion, and said anode and said cathode are located along said feeder portion proximate to said neck portion.

7. The microfluidic system according to claim 1, wherein said body includes a semiconductor chip.

8. The microfluidic system according to claim 7, wherein said valve means includes a voltage source, an anode deposited on said semiconductor chip and connected to said voltage source, and a cathode deposited on said semiconductor chip and connected to said voltage source, said anode and said cathode being arranged to apply a voltage across said fluid.

9. A microfluidic system comprising:
a semiconductor chip including a microfluidic channel through which a fluid flows, said channel including a feeder portion and a neck portion adjacent to and downstream from said feeder portion, said neck portion having a reduced cross-sectional area relative to said feeder portion; and
an anode and a cathode deposited on said semiconductor chip on opposite sides of said channel at a location along said feeder portion proximate said neck portion.

10. The microfluidic system according to claim 9, wherein said anode and said cathode communicate with said channel so as to contact fluid flowing through said channel.

11. A method of regulating flow of a fluid through a microfluidic channel, said method comprising the steps of:
inflating a gas phase bubble in said fluid at a location along said channel; and
maintaining said bubble at said location along said channel.

12. The method according to claim 11, wherein said bubble is maintained at said location by an inner wall of said channel.

13. The method according to claim 12, wherein said bubble is inflated electrochemically by applying a voltage across said fluid.

14. The method according to claim 13, wherein said applied voltage is chosen based at least in part on an inlet pressure of said fluid.

15. A method of temporarily stopping flow of a fluid through a microfluidic channel, said method comprising the steps of:
applying a voltage across said fluid to electrochemically inflate a gas phase bubble in said fluid;
maintaining said bubble at a fixed location along said channel; and
removing said voltage after a period of time to allow said bubble to deflate.
